(19) United States
(12) Patent Application Publication
(10) Pub. No.: US 2024/0202858 A1
(43) Pub. Date: Jun. 20, 2024

(54) RECOMMENDATION METHOD, ELECTRONIC DEVICE AND STORAGE MEDIUM

(71) Applicant: HON HAI PRECISION INDUSTRY CO., LTD., New Taipei (TW)

(72) Inventors: CHIH-TE LU, New Taipei (TW); YU-KAI ZHOU, New Taipei (TW); CHIN-PIN KUO, New Taipei (TW)

(21) Appl. No.: 18/129,788

(22) Filed: Mar. 31, 2023

(30) Foreign Application Priority Data
Dec. 16, 2022 (CN) 202211627796.4

(51) Int. Cl. G06Q 50/30

(52) U.S. Cl. CPC G06Q 50/30

(57) ABSTRACT

A recommendation method applied to an electronic device is provided. In the method, the electronic device determines an expected number of passengers getting off a compartment of a vehicle at each station. Based on a real-time number of passengers carried in the compartment and an expected number of passengers getting off the compartment, the electronic device can determine a remaining carrying space of the compartment and a recommended number of waiting passengers.

### FIELD

The present disclosure relates to the technical field of public transportation, in particular to a recommendation method, an electronic device, and a storage medium.

### BACKGROUND

Since it is not possible to determine how many people will get off a compartment of a vehicle (such as a subway) when the vehicle arrives at a station, a passenger waiting at the station usually cannot know in advance a remaining carrying space of a certain compartment of the vehicle before the vehicle arrives at the station, and cannot know in advance how many people can be accommodated by the remaining carrying space. The passenger usually needs to wait in line at a location corresponding to the certain compartment of the vehicle according to his own riding experience. It often happens that the passenger fails to board the certain compartment due to an overcrowding of the certain compartment. Such that the passengers need to spend time waiting for a next vehicle.

### BRIEF DESCRIPTION OF THE DRAWINGS

FIG. 1 is a flow chart of a method for recommending a number of passengers waiting for a vehicle provided by an embodiment of the present application.

FIG. 2 is a structural diagram of an electronic device provided by an embodiment of the present application.

### DETAILED DESCRIPTION

In order to more clearly understand the above objects, features and advantages of the present application, the present application will be described in detail below in conjunction with the accompanying drawings and specific embodiments. It should be noted that, in the case of no conflict, the embodiments of the present application and the features in the embodiments can be combined with each other.

A lot of specific details are set forth in the following description to facilitate a full understanding of the application, and the described embodiments are only a part of the embodiments of the application, rather than all the embodiments. Based on the embodiments in this application, all other embodiments obtained by persons of ordinary skill in the art without making creative efforts belong to the scope of protection of this application.

Unless otherwise defined, all technical and scientific terms used herein have the same meaning as commonly understood by one of ordinary skill in the technical field to which this application belongs. The terms used herein in the specification of the application are only for the purpose of describing specific embodiments, and are not intended to limit the application.

In one embodiment, since it is not possible to determine how many people will get off a compartment of a vehicle (such as a subway) when the vehicle arrives at a station, a passenger waiting at the station usually cannot know in advance a remaining carrying space of a certain compartment of the vehicle before the vehicle arrives at the station, and cannot know in advance how many people can be accommodated by the remaining carrying space. The passenger usually needs to wait in line at a location corresponding to the certain compartment of the vehicle according to his own riding experience. It often happens that the passenger fails to board the certain compartment due to an overcrowding of the certain compartment. Such that the passengers need to spend time waiting for a next vehicle.

In order to solve the above problems, a method for recommending a number of passengers waiting for a vehicle provided by the embodiment of the present application determines an expected number of passengers getting off a compartment of a vehicle at each station, by using a number prediction model; and determines a remaining carrying space of the compartment and a recommended number of waiting passengers at a next station based on a real-time number of passengers carried in the compartment and the expected number of passengers getting off the compartment at the next station. The method can determine the remaining carrying space and the recommended number of waiting passengers for each compartment of the vehicle, so that passengers can choose a compartment with a large recommended number of waiting passengers to queue up, thereby saving waiting time, effectively improving travel efficiency and effectively reducing safety hazards resulted because of the overcrowded number of passengers.

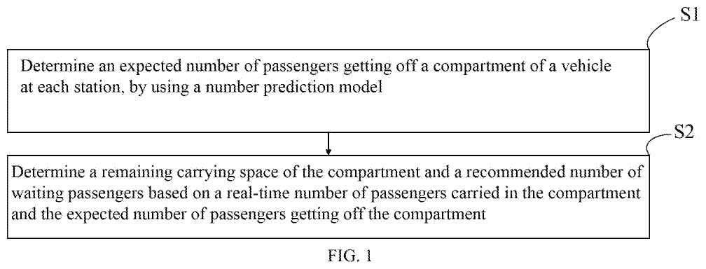

Referring to FIG. 1, it is a flow chart of the method for recommending the number of passengers waiting for a vehicle in one embodiment of the present application. To clearly describe the application, the “passengers waiting for a vehicle” hereinafter is referred as “waiting passengers”.

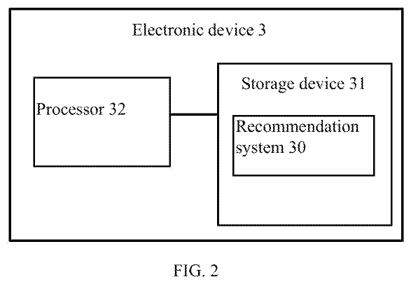

In this embodiment, the method for recommending the number of waiting passengers may be applied to an electronic device (such as the electronic device 3 shown in FIG. 2) installed in each compartment of a vehicle, and the electronic device may be a vehicle-mounted device. For a vehicle that needs to recommend the number of waiting passengers, the electronic device can directly integrate the function of recommending the number of waiting passengers provided by the method, or the function can be achieved by using a software development tool kit (SDK) run on the electronic device.

As shown in FIG. 1, the method for recommending the number of waiting passengers includes the following blocks. According to different requirements, the order of the blocks in the flow chart can be changed, and some blocks can be omitted.

At block S1, the electronic device determines an expected number of passengers getting off a compartment of a vehicle at each station, by using a pre-trained number prediction model.

In one embodiment, the electronic device trains the number prediction model according to a detailed procedure. In the procedure, the electronic device obtains compartment data of the compartment and historical carrying data of the compartment, and obtains an initial model by training an artificial neural network (ANN) based on the compartment data and the historical carrying data; and obtains the number prediction model by optimizing the initial model using an Adam optimizer algorithm until the number prediction model meeting preset requirements.

In one embodiment, the compartment data of the compartment includes, but is not limited to: a serial number of the vehicle, a serial number of the compartment, a station name of each station of the vehicle, an arrival time of the vehicle arrives at each station, and a running direction of the vehicle. The historical carrying data includes, but is not limited to: a historical carrying number of passengers at each station, a historical number of passengers getting on the compartment at each station, and a historical number of passengers getting off the compartment at each station.

In one embodiment, neurons in the artificial neural network are distributed in layers, and the layers includes: an input layer, a hidden layer, and an output layer. Among them, there is no connection between multiple neurons in a same layer; each neuron in a next layer is full connected to all neurons in a previous layer; each connection between two neurons includes a weight of connection; an output of neurons in the previous layer is used as an input of neurons in the next layer; the hidden layer can include multiple layers.

In one embodiment, considering that a format (for example, characters, numbers, etc.) of text data contained in the compartment data is different from a format of text data contained in the historical carrying data, when the compartment data and the historical carrying data are used as training samples for training the artificial neural network, the electronic device needs to encode some of the compartment data and the historical carrying data, for example, the electronic device encodes a station name of each station name as a first vector, and encodes the running direction as a second vector, so that the training samples are used as an input of the input layer of artificial neural network in a form of the vector.

In one embodiment, the artificial neural network is trained by repeatedly learning the training samples, and the electronic device gradually adjusts and changes the weight of connection between neurons to achieve a purpose of processing information. The electronic device simulates a relationship between a sample data as input and an expected number of passengers getting off as output, and obtains the initial model. The artificial neural network does not need to know an exact relationship between an input and an output, and does not need a large number of parameters. It only needs to know non-constant factors i.e., non-constant parameters (for example, the compartment data and the historical carrying data), that cause changes of the output. Therefore, compared with traditional data processing methods, an artificial neural network technology has obvious advantages in processing fuzzy data, random data, and nonlinear data. The method for recommending the number of passengers waiting for a vehicle in this embodiment of the application is particularly applicable to information having large-scale, complex structures, and being unclear.

In one embodiment, the Adam optimizer algorithm (Adam Optimizer) is a commonly used optimization algorithm for training deep neural network. Specifically, the Adam optimizer algorithm combines gradient descent algorithms (such as Mini-Batch, Momentum), and exponential weighted average algorithms.

The electronic device uses the Adam optimizer algorithm to optimize the initial model until the number prediction model that meets the preset requirements is obtained. In detail, the electronic device optimizes a weight of input and an offset of each neuron of the hidden layer in the initial model, and optimizes a weight of input and an offset of each neuron in the output layer until an accuracy rate of an output result of the output layer meets the preset requirement, for example, the accuracy rate is greater than 0.95.

In one embodiment, according to a detailed procedure, the electronic device determines the expected number of passengers getting off the compartment at each station by using the pre-trained number prediction model.

In the procedure, the electronic device obtains the compartment data of the compartment and a real-time number of passengers carried in the compartment.

Based on the compartment data of the compartment and the real-time number of passengers carried in the compartment, the electronic device outputs the expected number of passengers getting off the compartment at each station by using the number prediction model.

In one embodiment, the compartment data of the compartment includes, but is not limited to: the serial number of the compartment, the station name of each station and the arrival time that the vehicle arrives at each station, and the running direction of the vehicle.

In one embodiment, the electronic device further detects a number of passengers getting on the compartment at each station and detects a number of passengers getting off the compartment at each station, and determines the real-time number of passengers carried in the compartment according to the number of passengers getting on the compartment at each station and the number of passengers getting off the compartment at each station.

In one embodiment, each compartment is equipped with an object movement sensor or a human body sensor for detecting a human body. Specifically, the human body sensor may include an infrared sensor, and the infrared sensor may be installed at a position of a door of the compartment (such as a frame around the door) to detect the number of passengers getting on the compartment at each station and detect the number of passengers getting off the compartment at each station, so as to determine the real-time number of passengers carried in the compartment according to the number of passengers getting on the compartment at each station and the number of passengers getting off the compartment at each station.

Specifically, starting from an originating station of the vehicle, the electronic device detects the number of passengers getting on the compartment at each station and detects the number of passengers getting off the compartment at each station using the object movement sensor or the human body sensor. The electronic device adds up the number of passengers getting on the compartment at each station and subtracts the number of passengers getting off the compartment at each station, thereby, the electronic device obtains the real-time number of passengers carried in the compartment (for example, the real-time number equals 40).

In one embodiment, based on the compartment data of the compartment and the real time number of passengers carried in the compartment, the electronic device outputs the expected number of passengers getting off the compartment at each station by using the number prediction model.

In detail, the electronic device encodes the station name of each station as a first vector, and encodes the running direction as a second vector; inputs a vector that is constructed by the arrival time of the vehicle arrives at each station, the first vector, the second vector, the serial number of the compartment, and the real-time number of passengers carried in the compartment into the number prediction model and outputs the expected number of passengers getting off the compartment at each station using the number prediction model.

In other embodiments, the number prediction model can also be used to predict an expected number of passengers getting on the compartment at each station.

In one embodiment, since the real-time number of passengers carried in the compartment is updated in real time according to the number of passengers getting on the compartment and the number of passengers getting off the compartment at a current station when the vehicle arrives at the current station, so an expected number of passengers getting off the compartment at a next station can be obtained when a real-time number of passengers carried in the compartment at a previous station is updated, so that the passengers waiting at the next station can know the expected number of passengers getting off the compartment at the next station before the vehicle arrives at the next station.

Block S2, based on the real-time number of passengers carried in the compartment and the expected number of passengers getting off the compartment, the electronic device determines a remaining carrying space of the compartment and a recommended number of waiting passengers.

In one embodiment, based on the real-time number of passengers carried in the compartment and the expected number of passengers getting off the compartment at a next station, the electronic device determines a remaining carrying space of the compartment and a recommended number of waiting passengers at the next station.

In one embodiment, according to a detailed procedure, the electronic device determines the remaining carrying space of the compartment and the recommended number of waiting passengers at the next station.

In the procedure, the electronic device sets the remaining carrying space inversely proportional to the real-time number of passengers carried in the compartment, and sets the remaining carrying space proportional to the expected number of passengers getting off the compartment at a next station.

The electronic device further sets the recommended number of waiting passengers at the next station directly proportional to the expected number of passengers getting off the compartment at the next station.

In one embodiment, the electronic device determines the remaining carrying space of the compartment according to a formula S=1−(N1−N2)/M. S represents the remaining carrying space of the compartment, N1 represents the real-time number of passengers, N2 represents the expected number of passengers getting off the compartment at the next station, M represents a maximum number of passengers accommodated in the compartment. The remaining carrying space represents a predicted remaining density of passengers that can be accommodated in the compartment, the maximum number of passengers accommodated in the compartment is a known data provided by a manufacturer of the compartment, for example, the maximum number of passengers that can be accommodated is 101.

In one embodiment, the electronic device determines the recommended number of waiting passengers at the next station according to a formula N3=M−N1+N2−M*(1−t). N3 represents the recommended number of waiting passengers at the next station, M represents the maximum number of passengers accommodated in the compartment, N1 represents the real-time number of passengers, N2 represents the expected number of passengers getting off the compartment at the next station, t represents a preset congestion threshold. The preset congestion threshold t can be 0.9, the recommended number of waiting passengers at the next station N3 can be obtained based on the preset congestion threshold t, a space can be reserved for the compartment, so that the compartment will not be fully loaded or overloaded, and a comfort of passengers and driving safety can be improved.

In one embodiment, the electronic device further displays the remaining carrying space of the compartment and the recommended number of waiting passengers for the waiting passengers.

In one embodiment, the electronic device can send the remaining carrying space and the recommended number of waiting passengers in each compartment to a terminal platform associated with the vehicle through the network. For example, the terminal platform can be an application software or a small program installed in a mobile phone, or a display device installed at the corresponding station, etc. In this way, before the vehicle arrives at the next station, the waiting passengers at the next station can be shown the remaining carrying space of the compartment and the recommended number of waiting passengers corresponding to each compartment of the vehicle, so that the passengers can know a carrying status of each compartment and waits in line at a location corresponding to a compartment having more of the recommended number of waiting passengers, to avoid getting on failure.

In one embodiment, the method for recommending the number of waiting passengers provided by the present application determines the expected number of passengers getting off at a station according to the pre-trained number prediction model; based on the real-time number of passengers carried in the compartment and the expected number of passengers getting off, determines the remaining carrying space of the compartment and the recommended number of waiting passengers. The method can determine the remaining carrying space and the recommended number of waiting passengers for each compartment of the vehicle, so that passengers can choose a compartment with a large number of recommended waiting passengers to queue up, thereby saving waiting time, effectively improving travel efficiency and effectively reducing safety hazards that are resulted because of overcrowded passengers.

FIG. 1 describes in detail the method of recommending the number of waiting passengers of the present disclosure. Hardware architecture that implements the method of recommending the number of waiting passengers is described in conjunction with FIG. 2.

It should be understood that the described embodiments are for illustrative purposes only, and are not limited by this structure in the scope of the claims.

FIG. 2 is a block diagram of an electronic device provided by the present disclosure. The electronic device 3 may include a storage device 31 and at least one processor 32. It should be understood by those skilled in the art that the structure of the electronic device 3 shown in FIG. 2 does not constitute a limitation of the embodiment of the present disclosure. The electronic device 3 may further include other hardware or software, or the electronic device 3 may have different component arrangements.

In at least one embodiment, the electronic device 3 may include a terminal that is capable of automatically performing numerical calculations and/or information processing in accordance with pre-set or stored instructions. The hardware of terminal can include, but is not limited to, a microprocessor, an application specific integrated circuit, programmable gate arrays, digital processors, and embedded devices.

It should be noted that the electronic device 3 is merely an example, and other existing or future electronic products may be included in the scope of the present disclosure, and are included in the reference.

In some embodiments, the storage device 31 can be used to store program codes of computer readable programs and various data, such as the recommendation system 30 installed in the electronic device 3, and automatically access the programs or data with high speed during the running of the electronic device 3. The storage device 31 can include a read-only memory (ROM), a random access memory (RAM), a programmable read-only memory (PROM), an erasable programmable read only memory (EPROM), an one-time programmable read-only memory (OTPROM), an electronically-erasable programmable read-only memory (EEPROM)), a compact disc read-only memory (CD-ROM), or other optical disk storage, magnetic disk storage, magnetic tape storage, or any other storage medium readable by the electronic device 3 that can be used to carry or store data.

In some embodiments, the at least one processor 32 may be composed of an integrated circuit, for example, may be composed of a single packaged integrated circuit, or multiple integrated circuits of same function or different functions. The at least one processor 32 can include one or more central processing units (CPU), a microprocessor, a digital processing chip, a graphics processor, and various control chips. The at least one processor 32 is a control unit of the electronic device 3, which connects various components of the electronic device 3 using various interfaces and lines. By running or executing a computer program or modules stored in the storage device 31, and by invoking the data stored in the storage device 31, the at least one processor 32 can perform various functions of the electronic device 3 and process data of the electronic device 3. For example, the processor 32 may perform the function of recommending the number of waiting passengers shown in FIG. 1.

In some embodiments, the recommendation system 30 operates in electronic device 3. The recommendation system 30 may include a plurality of functional modules composed of program code segments. The program code of each program segment in the recommendation system 30 can be stored in storage device 31 of the electronic device 3 and executed by at least one processor 32 to achieve blocks as shown in FIG. 1.

In this embodiment, the recommendation system 30 can be divided into a plurality of functional modules. The module means a series of computer program segments that can be executed by at least one processor 32 and perform fixed functions and are stored in storage device 31.

The program codes are stored in storage device 31 and at least one processor 32 may invoke the program codes stored in storage device 31 to perform the related function. The program codes stored in the storage device 31 can be executed by at least one processor 32, so as to realize the function of each module to achieve the purpose of recommending the number of waiting passengers as shown in FIG. 1.

In one embodiment of this application, said storage device 31 stores at least one instruction, and said at least one instruction is executed by said at least one processor 32 for the purpose of recommending the number of waiting passengers as shown in FIG. 1.

Although not shown, the electronic device 3 may further include a power supply (such as a battery) for powering various components. Preferably, the power supply may be logically connected to the at least one processor 32 through a power management device, thereby, the power management device manages functions such as charging, discharging, and power management. The power supply may include one or more DC or AC power sources, a recharging device, a power failure detection circuit, a power converter or inverter, a power status indicator, and the like. The electronic device 3 may further include various sensors, such as a BLUETOOTH module, a WI-FI module, and the like, and details are not described herein.

In the several embodiments provided in this disclosure, it should be understood that the devices and methods disclosed can be implemented by other means. For example, the device embodiments described above are only schematic. For example, the division of the modules is only a logical function division, which can be implemented in another way.

The modules described as separate parts may or may not be physically separate, and the parts displayed as modules may or may not be physical units, that is, may be located in one place, or may be distributed over multiple network units. Part or all of the modules can be selected according to the actual needs to achieve the purpose of this embodiment.

In addition, each functional unit in each embodiment of the present disclosure can be integrated into one processing unit, or can be physically present separately in each unit, or two or more units can be integrated into one unit. The above integrated unit can be implemented in a form of hardware or in a form of a software functional unit.

The above integrated modules implemented in the form of function modules may be stored in a storage medium. The above function modules may be stored in a storage medium, and include several instructions to enable a computing device (which may be a personal computer, server, or network device, etc.) or processor to execute the method described in the embodiment of the present disclosure.

The present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names but not to signify any particular order.

The above description is only embodiments of the present disclosure and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. A recommendation method applied to an electronic device, the method comprising:
determining an expected number of passengers getting off a compartment of a vehicle at each station, by using a number prediction model; and
determining a remaining carrying space of the compartment and a recommended number of waiting passengers based on a real-time number of passengers carried in the compartment and the expected number of passengers getting off the compartment.

2. The recommendation method according to claim 1, further comprising:
obtaining compartment data of the compartment and historical carrying data of the compartment, and obtaining an initial model by training an artificial neural network based on the compartment data and the historical carrying data; and
obtaining the number prediction model by optimizing the initial model using an Adam optimizer algorithm until the number prediction model meeting preset requirements.

3. The recommendation method according to claim 1, wherein the determining of the expected number of passengers getting off the compartment at each station comprises:
obtaining compartment data of the compartment and a real-time number of passengers carried in the compartment; and
outputting the expected number of passengers getting off the compartment at each station by using the number prediction model based on the compartment data of the compartment and the real-time number of passengers carried in the compartment.

4. The recommendation method according to claim 3, wherein the compartment data of the compartment comprises a serial number of the vehicle, a serial number of the compartment, a station name of each station, an arrival time of the vehicle arrives at each station, and a running direction of the vehicle;
wherein the outputting of the expected number of passengers getting off the compartment at each station comprises:
encoding the station name of each station as a first vector, and encoding the running direction as a second vector;
outputting the expected number of passengers getting off the compartment at each station using the number prediction model by inputting a vector that is constructed by the arrival time of the vehicle arrives at each station, the first vector, the second vector, the serial number of the compartment, and the real-time number of passengers carried in the compartment into the number prediction model.

5. The recommendation method according to claim 1, further comprising:
detecting a number of passengers getting on the compartment at each station and detecting a number of passengers getting off the compartment at each station; and
determining the real-time number of passengers carried in the compartment according to the number of passengers getting on the compartment at each station and the number of passengers getting off the compartment at each station.

6. The recommendation method according to claim 1, wherein the determining of the remaining carrying space of the compartment and the recommended number of waiting passengers at the next station comprises:
setting the remaining carrying space inversely proportional to the real-time number of passengers, and setting the remaining carrying space proportional to the expected number of passengers getting off the compartment at a next station; and
setting the recommended number of waiting passengers at the next station directly proportional to the expected number of passengers getting off the compartment at the next station.

7. The recommendation method according to claim 1, further comprising:
displaying the remaining carrying space of the compartment and the recommended number of waiting passengers for the waiting passengers.

8. An electronic device comprising:
a storage device;
at least one processor; and
the storage device storing one or more programs, which when executed by the at least one processor, cause the at least one processor to:
determine an expected number of passengers getting off a compartment of a vehicle at each station, by using a number prediction model; and
determine a remaining carrying space of the compartment and a recommended number of waiting passengers based on a real-time number of passengers carried in the compartment and the expected number of passengers getting off the compartment.

9. The electronic device according to claim 8, wherein the at least one processor is further caused to:
obtain compartment data of the compartment and historical carrying data of the compartment, and obtain an initial model by training an artificial neural network based on the compartment data and the historical carrying data; and
obtain the number prediction model by optimizing the initial model using an Adam optimizer algorithm until the number prediction model meeting preset requirements.

10. The electronic device according to claim 8, wherein the at least one processor determines the expected number of passengers getting off the compartment at each station by:
obtaining compartment data of the compartment and a real-time number of passengers carried in the compartment; and
outputting the expected number of passengers getting off the compartment at each station by using the number prediction model based on the compartment data of the compartment and the real-time number of passengers carried in the compartment.

11. The electronic device according to claim 10, wherein the compartment data of the compartment comprises a serial number of the vehicle, a serial number of the compartment, a station name of each station, an arrival time of the vehicle arrives at each station, and a running direction of the vehicle;
wherein the at least one processor outputs the expected number of passengers getting off the compartment at each station by:
encoding the station name of each station as a first vector, and encoding the running direction as a second vector;
outputting the expected number of passengers getting off the compartment at each station using the number prediction model by inputting a vector that is constructed by the arrival time of the vehicle arrives at each station, the first vector, the second vector, the serial number of the compartment, and the real-time number of passengers carried in the compartment into the number prediction model.

12. The electronic device according to claim 8, wherein the at least one processor is further caused to:
detect a number of passengers getting on the compartment at each station and detect a number of passengers getting off the compartment at each station; and
determine the real-time number of passengers carried in the compartment according to the number of passengers getting on the compartment at each station and the number of passengers getting off the compartment at each station.

13. The electronic device according to claim 8, wherein the at least one processor determines the remaining carrying space of the compartment and the recommended number of waiting passengers at the next station by:
setting the remaining carrying space inversely proportional to the real-time number of passengers, and setting the remaining carrying space proportional to the expected number of passengers getting off the compartment at a next station; and
setting the recommended number of waiting passengers at the next station directly proportional to the expected number of passengers getting off the compartment at the next station.

14. The electronic device according to claim 8, wherein the at least one processor is further caused to:
display the remaining carrying space of the compartment and the recommended number of waiting passengers for the waiting passengers.

15. A non-transitory storage medium having instructions stored thereon, when the instructions are executed by a processor of an electronic device, the processor is caused to perform a recommendation method, wherein the method comprises:
determining an expected number of passengers getting off a compartment of a vehicle at each station, by using a number prediction model; and
determining a remaining carrying space of the compartment and a recommended number of waiting passengers based on a real-time number of passengers carried in the compartment and the expected number of passengers getting off the compartment.

16. The non-transitory storage medium according to claim 15, wherein the method further comprises:
obtaining compartment data of the compartment and historical carrying data of the compartment, and obtaining an initial model by training an artificial neural network based on the compartment data and the historical carrying data; and
obtaining the number prediction model by optimizing the initial model using an Adam optimizer algorithm until the number prediction model meeting preset requirements.

17. The non-transitory storage medium according to claim 15, wherein the determining of the expected number of passengers getting off the compartment at each station comprises:
obtaining compartment data of the compartment and a real-time number of passengers carried in the compartment; and
outputting the expected number of passengers getting off the compartment at each station by using the number prediction model based on the compartment data of the compartment and the real-time number of passengers carried in the compartment.

18. The non-transitory storage medium according to claim 17, wherein the compartment data of the compartment comprises a serial number of the vehicle, a serial number of the compartment, a station name of each station, an arrival time of the vehicle arrives at each station, and a running direction of the vehicle;
wherein the outputting of the expected number of passengers getting off the compartment at each station comprises:
encoding the station name of each station as a first vector, and encoding the running direction as a second vector;
outputting the expected number of passengers getting off the compartment at each station using the number prediction model by inputting a vector that is constructed by the arrival time of the vehicle arrives at each station, the first vector, the second vector, the serial number of the compartment, and the real-time number of passengers carried in the compartment into the number prediction model.

19. The non-transitory storage medium according to claim 15, wherein the method further comprises:
detecting a number of passengers getting on the compartment at each station and detecting a number of passengers getting off the compartment at each station; and
determining the real-time number of passengers carried in the compartment according to the number of passengers getting on the compartment at each station and the number of passengers getting off the compartment at each station.

20. The non-transitory storage medium according to claim 15, wherein the determining of the remaining carrying space of the compartment and the recommended number of waiting passengers at the next station comprises:
setting the remaining carrying space inversely proportional to the real-time number of passengers, and setting the remaining carrying space proportional to the expected number of passengers getting off the compartment at a next station; and
setting the recommended number of waiting passengers at the next station directly proportional to the expected number of passengers getting off the compartment at the next station.
